(19) United States
(12) Patent Application Publication
(10) Pub. No.: US 2010/0175026 A1
(43) Pub. Date: Jul. 8, 2010

(54) SYSTEM AND METHOD FOR GRAPHICAL CONTENT AND MEDIA MANAGEMENT, SORTING, AND RETRIEVAL

(76) Inventors: Christopher F. BORTNER, York, PA (US); Daniel M. HOMYK, Oak Hill, VA (US); Gavin MCDONALD, Fairfax, VA (US); Thomas M. WELSH, Fairfax Station, VA (US)

Correspondence Address: BLANK ROME LLP, WATERGATE, 600 NEW HAMPSHIRE AVENUE, N.W., WASHINGTON, DC, 20037, US

(21) Appl. No.: 12/652,620

(22) Filed: Jan. 5, 2010

Related U.S. Application Data
(60) Provisional application No. 61/142,525, filed on Jan. 5, 2009.

(51) Int. Cl. G06F 3/048

(52) U.S. Cl. 715/818; 715/825; 715/823

(57) ABSTRACT

A system and method graphically displays similar or disparate forms of information for the purpose of sorting, searching, organizing, accessing, and using the information that contains a revolving carousel, limits the amount of information displayed by a subset setting, and having sorting commands directly accessible to the user through a remote control or other input device. The carousel design allows the user to easily see the information that is of interest and navigate to the information using commands to spin the carousel right or left, or use the sort, sub-sort, search, or text skip ahead commands. The graphical nature and intuitive operation enables the user to quickly learn, navigate, find, access, or act on the information that they are looking for.

### CROSS-REFERENCE TO RELATED APPLICATIONS

The present application claims priority to provisional application Ser. No. 61/142,525, filed Jan. 5, 2009, the contents of which are incorporated herein by reference.

### FIELD OF THE INVENTION

The present invention relates to a system for displaying information to a user. More particularly, the present invention relates to a system for displaying multiple elements of information to a user in a carousel.

### BACKGROUND OF THE INVENTION

This invention relates to a system and method to manage and present information, media, content, search results, and sorts to a user(s) in an easy to understand graphical manner using a large display and a remote control or other command input device. There has been an explosion of digital media (pictures from digital cameras, music from CDs and Internet downloads, videos from camcorders and Internet sites, movies from DVD and Internet downloads) that consumers generate or purchase and users need an new innovative way to manage the access to the incredible range of information that is available to them. This has happened at the same time that there has been a convergence of different industries (telecommunications, cable TV, satellite TV, computer, and Internet services) bringing the computer and Internet into the living room. Many inventions have focused on the ways for users to get more and better search results. But, the present invention may change the way the a user interacts with information, products, content, or media that the user is interested in accessing. The benefit to the consumer is to have an easy way to visually see, interact with, sort, find, and select the information, content, media, or product that they want from a distance while they are on their couch.

U.S. Pat. No. 7,437,351 to Page is a Method for Searching Media and is an example of inventions that address the gathering of search results but does not address how the information that the user is requested is organized, sorted, and presented to the user. In fact, every patent searched focused on methods for searching for information and not on an invention for which the results of a search (typically on the Internet) are presented to the user.

### SUMMARY OF THE INVENTION

According to the invention, a system and method is provided that focuses on the process for aggregating information (media, content, products, services, search results, sort results) and organizing the information into graphical images displayed to a user to enable easy review, retrieval, selection, access, or manipulation. FIGS. 1-6 are representations of how information may be presented to a user on a TV, monitor, display, projector, screen, or other device designed to show images. The information may be organized in a carousel that spins left or right based on input from the user. FIG. 5 shows how different areas of the display may be configured to convey information to the user. FIG. 1 shows a screen shot of an actual implementation of this GUI.

In accordance with the invention, all of the results (from sort, search, etc.) may be contained in the carousel with only a subset of the results being visible to the user at a given time. The number of elements in the subset can be changed to accommodate user preference, functionality for screen size, image size, or responsiveness of user interface. For example, if the user has currently selected all music CDs in their collection that begins with the letter “R”, and the subset is set to 15 elements, then only 15 images would be shown on the screen to represent 15 of the CDs. As the user spins the carousel left or right then images would appear in the direction the user spins and disappear on the trailing edge of the carousel. This invention enables the same user interface to be used to display any amount of information (data elements) without requiring the user to page up or down, or to refresh the screen.

The addition of a sort command, which is available to the user (through a remote control, keyboard, mouse, voice command, or other device that receives user commands), that enables the user to select predetermined sorts of the information to be displayed on the carousel. The predefined sorts can either be previously defined by the user, default sorts, determined by the type of information being sorted, or determined by data associated with the information. This differs from prior art, which requires the user to select a sort feature and then select the type of sort. The one step sort command significantly simplifies the use for the user and speeds access to the required information.

The carousel 1) can contain large amounts of data elements (search or sort results) while limiting the number results shown to the user at once through the subset setting, 2) has a sort command and 3) the graphical nature of the data element representation enable this user interface to easily be used for any type of media, content, product, or service. This invention of aggregating information (media, content, products, services, search results) using these three features enables users to easily sort though disparate or similar types of information with the same easy method. A carousel can contain many different types of information and results. For example, if the user searching an online store using the search phrase “Beatles” then the results could contain music from the band The Beatles, books about the band The Beatles, movies about The Beatles, and clothes with The Beatles on them. Using the sort button, the user would dynamically be presented with the different ways this data could be sorted (Music, Books, Movies, Clothes, etc.).

### BRIEF DESCRIPTION OF THE DRAWINGS

FIG. 1 shows the Graphic User Interface (GUI) of the preferred embodiment of the invention, with a subset setting of 15 and 83 elements in the carousel;

FIG. 2 shows a detailed information view;

FIG. 3 is a carousel layout for a subset setting of 15 elements, with greater than 15 elements in the carousel;

FIG. 4 is a carousel layout for 15 elements, with exactly 15 elements in the carousel;

FIG. 5 is an illustrative embodiment of textual and graphical area for user information;

FIG. 6 is an illustrative embodiment of the carousel layout for a subset setting of 15 elements, with only 5 elements in the carousel;

FIG. 7 is a front plan view of the controller of the present invention;

FIG. 8 is a rear plan view of the controller;

FIG. 9 is a top plan view of the remote control device; and

FIG. 10 is a flow chart showing operation of the controller.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose.

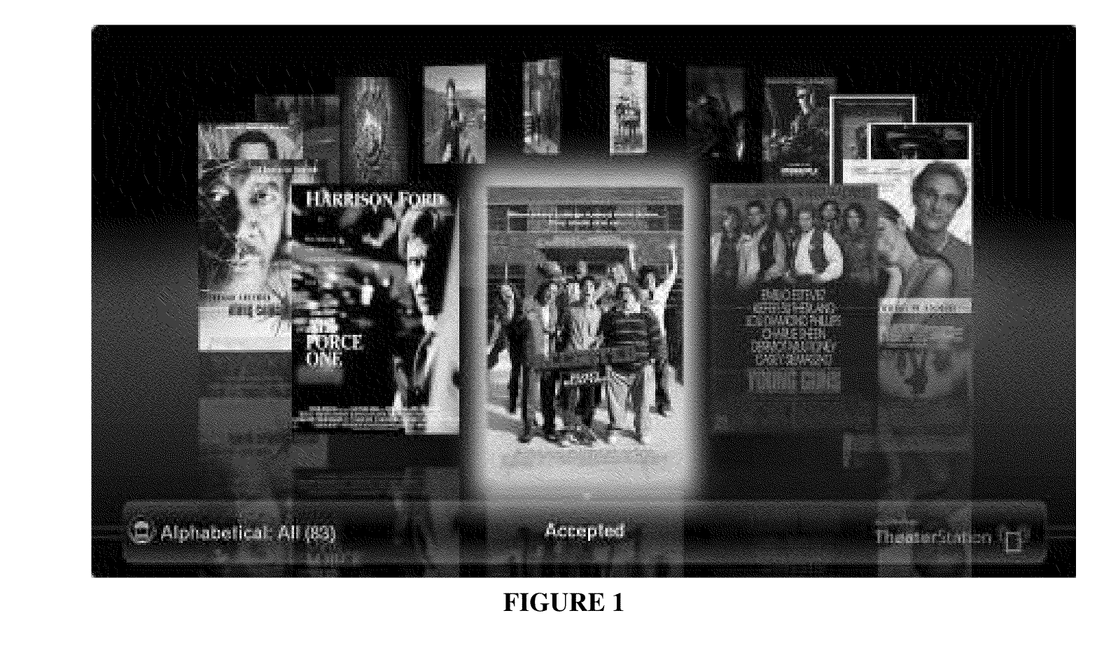

Turning to the figures, FIG. 1 is an example of an implementation of a Graphical User Interface (GUI) using the system and method of the present invention. As illustrated, the invention is utilized to provide a user with information about movie titles available to the user. In the illustrated embodiment, there are 15 elements (i.e., movies) displayed, and there are a total of 83 elements in the carousel. The invention allows for users to assign graphical images to information using Internet image searches or using images that have been made locally available to the system by a hard drive file, attached device (like USB drive), or on the local network.

The ability for the user to select and customize the images assigned to the information enables the user to personalize their experience using this invention. Many pieces of information (media) contain meta data, which is data that describes and provides information about the media. According to this invention, information may be used as a way to enable sorts and search of the information. This enables the user to find information quicker, more easily, more enjoyably, and to handle different forms of information. The invention may also provide the user with ways to add or edit meta data to further customize their experience using the invention.

A preferred implementation of the invention for graphically displaying, sorting, searching, and selecting information is a software program or series of programs running on a computer system connected to a display device. A programmer may write the software to act as a Graphical User Interface (GUI) to enable a user to graphically view, sort, search, access, and manipulate information that was either contained on, connected to, or accessible by the computer system. To implement this invention, a graphical image may be assigned to each piece of information that will be presented to the user. A generic image, like a graphic that says Missing Image, can be displayed for all information that does not yet have an image assigned to it. For information that comprises media, like music or movies, the cover art of the CD or DVD is typically used as the display image for the information.

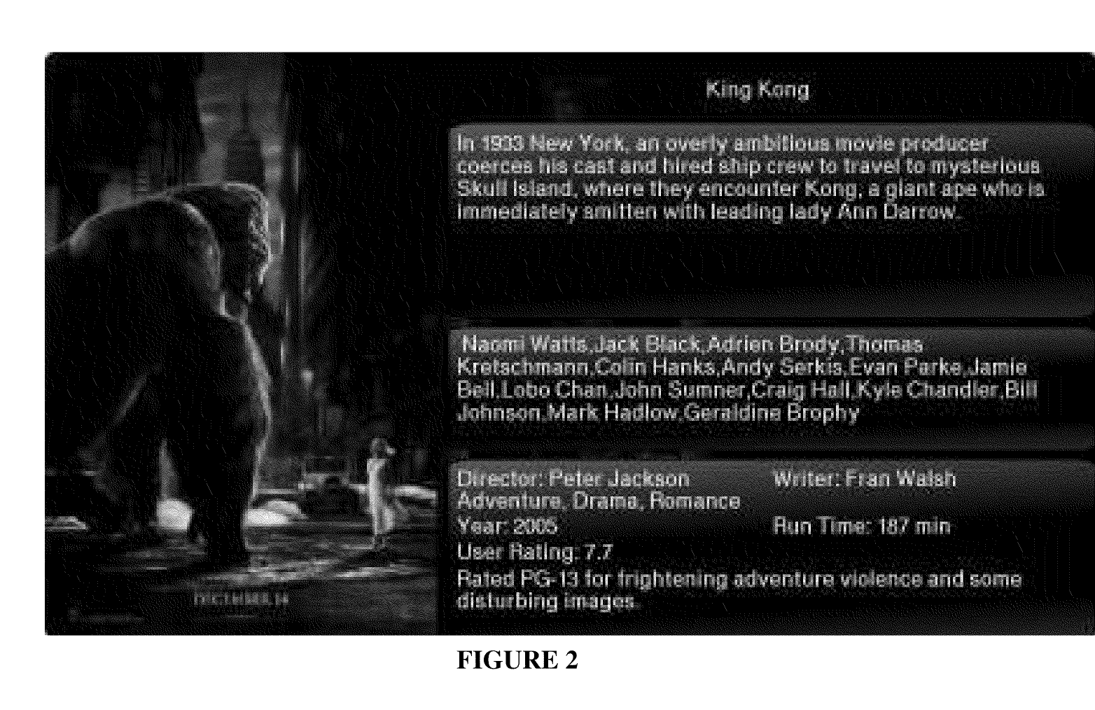

FIG. 2 shows an example of a detailed information screen about a selected movie title that displays a user selectable image and user editable meta data.

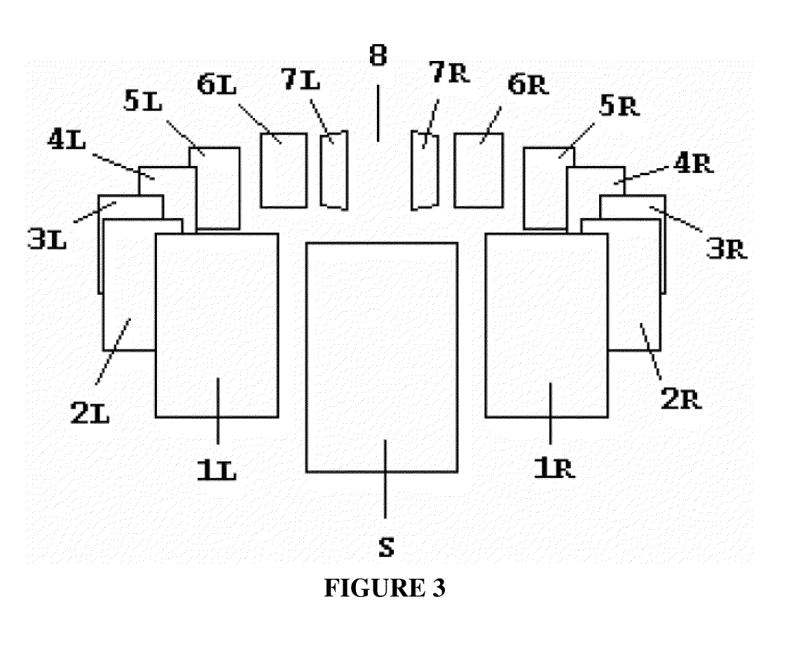

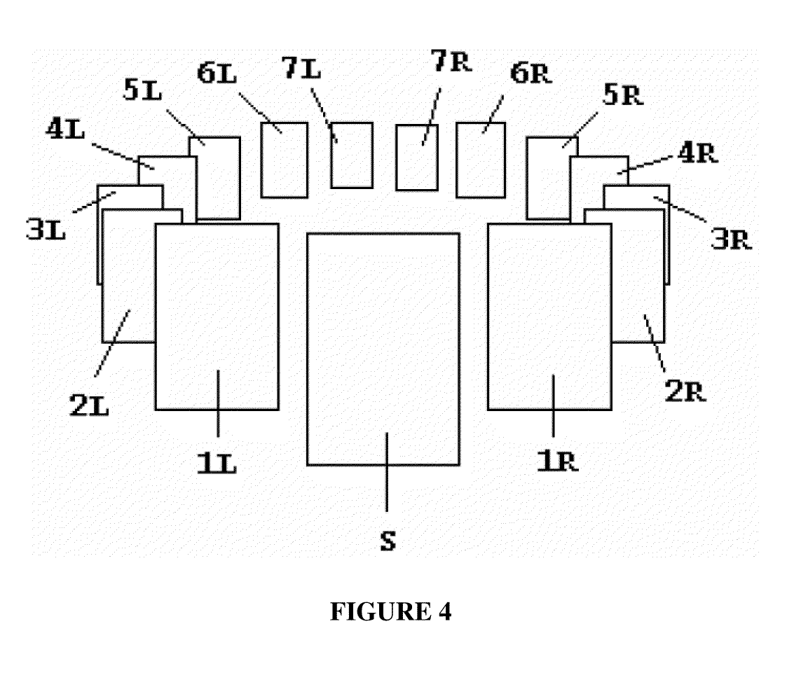

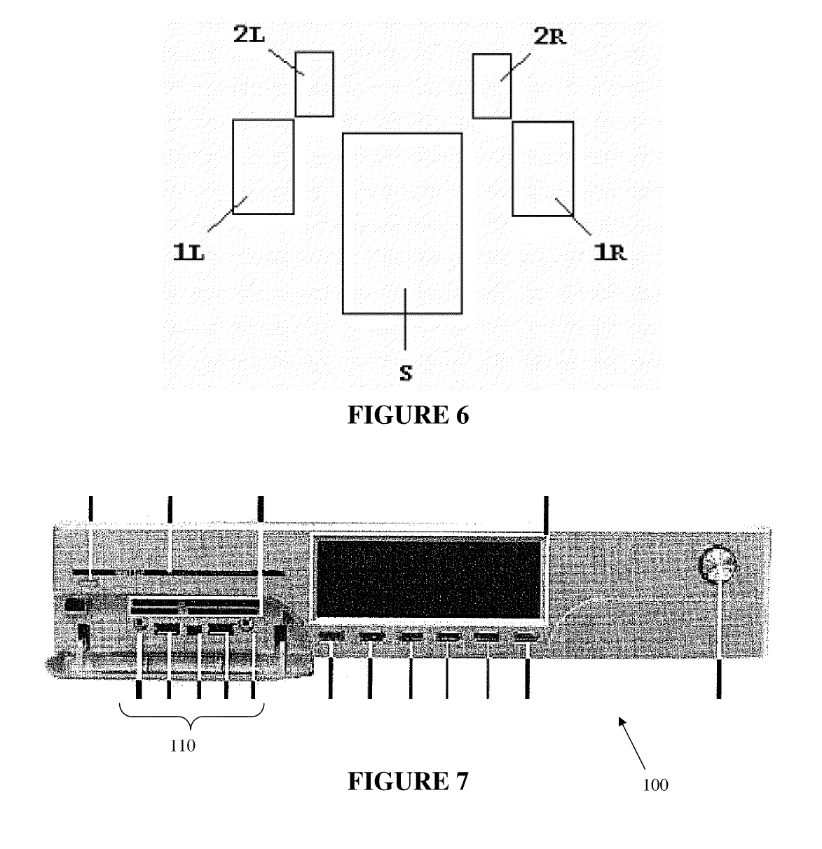

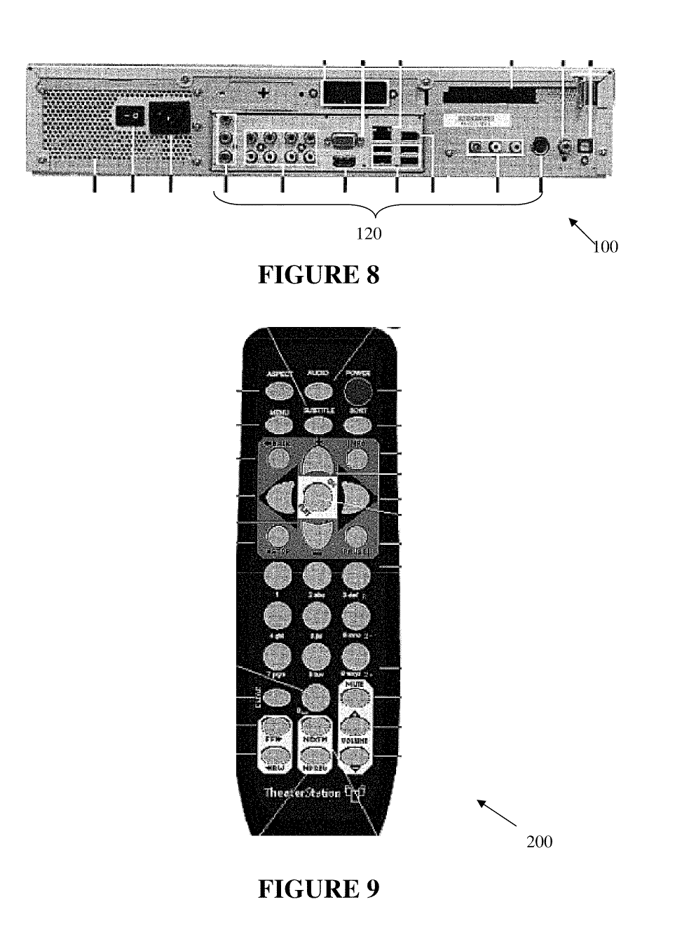

FIG. 3 shows an example of how the carousel positions could appear on a screen. Other configurations and implementations of this invention are possible. This example is based on a subset setting of 15 elements and assumes that more than 15 elements are available in the carousel to be displayed. Since only 15 elements are displayed, and there are more than 15 elements in this search or sort carousel, then the graphical images for those elements are not displayed. They are logically placed on the carousel between the locations 7L and 7R on FIG. 3 but their corresponding graphical images are not displayed. This prevents screen clutter and keeps the GUI clear for the user. FIG. 4 shows how the graphical images could be displayed if there are exactly 15 elements in the carousel and the subset setting is equal to 15. In this case the images in position 7L and 7R are displayed as rectangles (flat) and there is no position 8, since all the images in the carousel are displayed. When the number of images to be displayed are less than the subset setting then the position of the images around the carousel are spread out so that they still convey the circular notion of a carousel to the user. See FIG. 6 for an example of this. It is left to the implementation of the invention to define the exact layout and position of the images for the different combinations of Graphical Images being displayed when this value is less than the Subset Setting.

Textual or graphical information may be displayed at different locations on the screen to show the name of the selected element, the current sort or sub-sort, the number of elements in the carousel, the type of information in the carousel, the status of actions by the user, and the progress of playing or copying media.

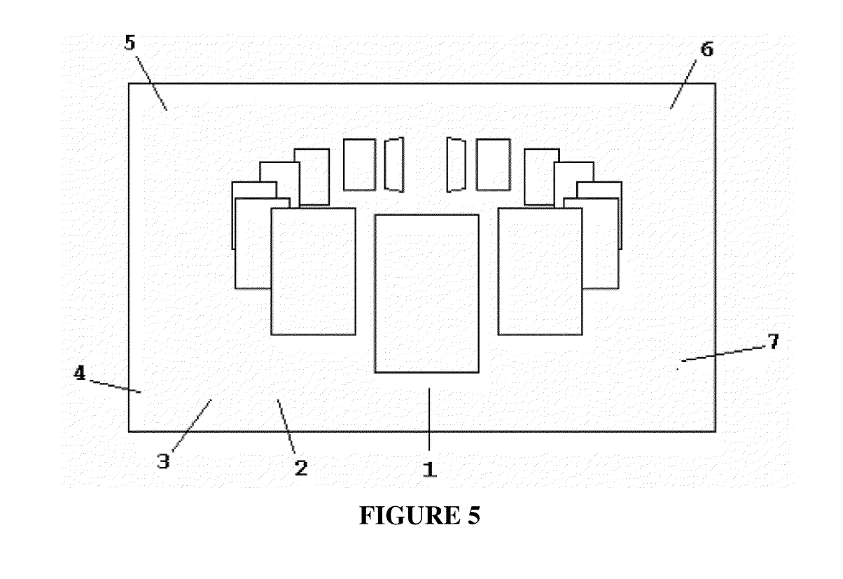

FIG. 5 shows an example of one implementation for how textual and graphic information could be shown on the screen around the carousel to provide information to the user. FIGS. 3-5 have different positions on the carousel and the locations on the screen for textual and graphic information. The S position shows the current selected element of the carousel. This is a special position in the carousel because information about this element can be displayed and addition actions can be taken from this position. For example, if it is a movie, the Title can be displayed below it, it can be played by the user issuing a command (by remote control, keyboard, voice, RS232, IP, or any other means the system can accept commands). Addition options are presented to the user for the selected element. These options are dependent on the type of element. Example: If element is music then the user would be able to play the music, view info about the music (artist, tracks, etc.), edit information, play specific track, etc. If the element is a product the user wishes to purchase then the options would be purchase product, get product details, add to cart, add to wish list, etc.

The 1R position is one position to the right of the selected element and can be selected by spinning the carousel to the right one position using the right command (by remote control, keyboard, voice, RS232, IP, or any other means the system can accept commands). Likewise, the 2R-7R positions are two-seven positions, respectively, to the right of the selected element and can be selected by spinning the carousel to the right two-seven positions, respectively, using the right command (by remote control, keyboard, voice, RS232, IP, or any other means the system can accept commands).

The 1L position is one position to the left of the selected element and can be selected by spinning the carousel to the left one position using the left command (by remote control, keyboard, voice, RS232, IP, or any other means the system can accept commands). Likewise, the 2L-7L positions are two-seven positions, respectively, to the left of the selected element and can be selected by spinning the carousel to the left two-seven positions, respectively, using the left command (by remote control, keyboard, voice, RS232, IP, or any other means the system can accept commands).

The area 1 shows a pointer to the selected element and textually displays the elements name or information that describes the element. For instance, in FIG. 1 the name of the movie “Accepted” is displayed. The number of elements 2 in the current carousel is displayed. For instance, in FIG. 1, the total number of elements (i.e., movies in the illustrated embodiment) 2 in the carousel is 83. The current sort type 3 (example: Alphabetical or Genre) or the search criteria (example: Beatles) is also displayed. In FIG. 1, the sort type 3 is shown as Alphabetical. The current mode or type of data 4 being displayed on the carousel, preferably as a graphic. In FIG. 1, an icon is shown for movies. Other types of data 4 include music, pictures, and search results.

A multipurpose area 5 is provided which shows information to the user. It can be used to show the name and title of content that is being added to the memory. It can also be used to show the status to the user of connection to new content, and other multiple purposes. The user progress status 6 is provided to display copies and other actions taken by the user. This is also a multipurpose area. The media information 7 is provided to display information to the user about the content that is currently being played. It is also a multipurpose area.

A blank area 8 is shown in FIGS. 3 and 5, and is where it appears that all elements go when they rotate off of the carousel. This blank area 8 is important to limiting the amount of information that is presented to the user. This area is used to “hold” elements whenever the carousel contains more elements then the subset setting. For instance, if the number of elements to be displayed (referred to as subset setting) is seven and only six elements are returned from the search/sort, then all six will be displayed, as shown in FIG. 4 for fifteen elements. If the search/sort returns eight elements, then only seven would be displayed and the eighth element would only be seen when the carousel is rotated.

A number of actions are available which permit the user to control the GUI. These actions are taken in response to commands received from the user. These user commands can be a result of remote control, keyboard, mouse, voice, RS232, IP, or any other input that is designed to enable user commands to control actions. For instance, the Right command is an action which causes the carousel to rotate to the right to the next element. The Left command or action causes the carousel to rotate to the left to the next element. The Sort Up action causes a new sort of the information to produce a new carousel of elements. The Up implies the direction through which the predefined list of available sorts will be traversed. The Sort Down action causes a new sort of the information to produce a new carousel of elements. The Down implies the direction through which the predefined list of available sorts will be traversed. The Sort Down would be the opposite direction of the Sort Up.

The Information command causes more detailed information about the element that is selected to be displayed. The type of information and the options displayed are dependent on the type of element selected (Movie, Music, Product, Service, etc.). The Sub-Sort Up action causes a new sort of the information to a new carousel of elements but the new sort is organized as a sub-sort of the existing sort. The Up implies the direction through which the predefined list of available sub-sorts will be traversed. The Sub-Sort Up would be the opposite direction of the Sub-Sort Down. For instance, if the user selects an Alphabetical Sort, then the Sub-Sort Up would take the user through sub-sorts (#, A, B, C, etc.). The Sub-Sort Down action causes a new sort of the information to a new carousel of elements but the new sort is organized as a sub-sort of the existing sort. The Down implies the direction through which the predefined list of available sub-sorts will be traversed. The Sub-Sort Down would be the opposite direction of the Sub-Sort Up. Example: If the user selects an Alphabetical Sort, then the Sub-Sort Down would take the user through sub-sorts (Z, Y, X, V, etc.).

The Search action causes a search window to open so that the user can enter a search request. The search window has The results of the search will be presented in a carousel according to the results and the subset setting. The Text Skip Ahead action causes the carousel to spin to the next element that corresponds with the text command Example: If the carousel is an alphabetical list of products, then issuing the “J” command (which would be pressing the 5 button on the remote control) would rotate the carousel to the first element that starts with a J or the available alphabetical character. Pressing the 5 button again would rotate to the first element that starts with a K. The Menu action causes a Menu to open that presents the user with options based on the position in the user interface and the element that is selected.

The Mode action causes the user interface to change to a different set of elements to be displayed on the carousel. Specific Mode Commands can be mapped to specific sets of elements. Example: A mode change could change from Movies to Music and then to Home Movies. Specific Mode Commands can be assigned to take a user directly to Pictures, Movies, Music, etc. This requires a specific mode command to be liked to each desired mode.

The Buy action causes initiates the process of purchasing the currently selected element. The user will have the option of storing their purchase information (like credit card or PayPal information) to speed the process on subsequent purchases. Control is a set of actions that is determined by the selected element. If this selected element is a movie, then the controls would be Play, Stop, Pause, Fast Forward, Rewind, Skip Forward, Skip Backward, Information, Menu. The control actions for picture would be Play Slideshow, Edit, Rotate, Fix Red Eye, Place is Album.

When the Sort command/action is requested by the user then the current carousel may be replaced with a new carousel and the images on the screen may be updated to reflect the assigned images for the elements of the new carousel. A visual cue may be provided to indicate to the user why the carousel has changed. For instance, the current carousel disappears and the newly loaded content appears from the center of the screen and expands out to meet the standard diameter of the carousel, so that the different items in the carousel don't seem to suddenly change their pictures without offering the notion that a new selection has appeared and is available.

Again, if the number of elements in the carousel is greater than the subset setting, then the number of graphical images displayed would be equal to the subset setting and the remaining images would not be displayed according to invention. The same invention may be used if the results to be displayed come from a search command/action. The sort commands/actions available to the user may be implemented by determining the types of sorts that the program wishes to make available to the user. These are called predetermined sorts. A list of these sorts can offered to the user to directly access through the Sort Up and Sort Down commands/actions. The programmer may implement this method by writing algorithms to sort through the information and create a new carousel of graphic images to be displayed to the user according to the methods provided above.

The number of predefined sorts, the types of sorts, and the order of the sorts is left to the programmer's discretion and implementation. It is possible for the programmer to make the number of sorts, types of sorts, and order of the sorts programmable so that they can be easily changed by the end user to customize their system. The programmer can also implement sort options to the user based on the type of information provided. For example, if the user directed the system to show information from an Internet based products company like www.amazon.com, then the programmer could enable sorting options for the user based on the types of products available (Books, CDs, DVDs, Toys, electronics, etc.). These sorts need not be predetermined but may instead be dynamic in nature and dependent on the meta data (or just data) that describes the information. Product databases for online companies typically include pictures, pricing, features, descriptions, and category information that the programmer can use to create dynamic sort and search options for the user.

The present invention may be run on a computer that has connections to enable it to display the GUI implementation on a large display and be controlled with a remote control. The user's manual shows how the menu structure and command structures can be implemented to create a functional product from this invention for graphically displaying, sorting, searching, accessing, and manipulation information, media, and content.

A procedure for how this invention may be used to sort, search, and navigate information is as follows. The invention displays on the screen a carousel with elements shown from the current sort or search results. If no elements meet the search or sort criteria then a message is presented that no elements meet the criteria. If the number of elements that meet the criteria is greater than 0 and less than or equal to the subset setting, then all of these elements are displayed in the carousel. If the number of elements that meet the criteria is greater than subset setting, then only a number of element equal to the subset setting are displayed and the remaining elements will be displayed as the user rotates Right or Left or issues additional commands (actions).

The user issues one or more of the commands which are available to the user, and can take other actions. The elements in the carousel and the elements displayed on the screen are updated according to the command issues by the user and the results of the action, which are frequently dependent on the data elements and the user's command. This continues until the user issues a command which is not a navigation, sort, or search command, but rather another action, such as an action that starts the media playing, starts a purchase transaction, or other action. The operation of the user interface, that this invention enables, may be performed by using the commands. The user may be presented with graphical information presented in the form shown in FIG. 1.

The present invention allows the user to create a customized movie and music library with the click of a button. The user can electronically store home and studio movie collections in an easy-to-use format, electronically store a user's music collection, de-clutter the entertainment area by storing DVDs and CDs somewhere else for safe keeping, and quickly select a movie or music from the visually dynamic carousel-style interface on the TV screen. In addition, the user can instantly sort the movies by alphabet, year, rating, movie length, genre etc. The user can also view a movie and load another movie simultaneously and listen to music while loading movies or music.

The invention has full-featured parental controls with passcode access, supports resolutions of 480i, 480p, 720p, 1080i, 1080p, supports HDMI (High-Definition Multimedia Interface) and Component outputs, and supports 480i over AV output (composite) or S-Video (Separate Video). In addition, the invention has stereo, 7.1 Surround, Digital Pass Thru (SPDIF —Sony Philips Digital Interface) audio output. It has a Wired or Wireless network connection, front panel control, and movie and music information and cover download via Internet. It further has standard AV equipment dimensions—12.6″(D)×16.9″(W)×3.1″(H)—and service for easy updates.

In accordance with a preferred embodiment, the invention is a controller 100 with a remote control device 200. The controller 100 includes inputs 110 and outputs 120. The outputs 120 include video and audio ports to receive connections such as, for instance, an HDMI cable for a HDMI-compatible TV. A wired network connection can be used by connecting an Ethernet cord to the back of the controller 100. A wireless connection can also be used. The front panel of the controller 100 includes the following inputs 110: USB (Universal Serial Bus) 2.0 Port for USB devices (i.e. keyboard, speakers, etc.); IEEE 1394 Port (4-pin) for FireWire or i.LINK cables; and, headphone port for a headphone to be plugged in. In addition, the following command signals are provided on the front panel: Stop Button, to display/remove main menu and stop a movie and returns to home screen; Play Button, to play selected movie or select the desired action from a menu, and to play the selected movie; Replay Button to sort movies by category down or step through menu choices down, and to step backward through chapters; Rewind Button, to rotate through library to the left or step through menu choices left, and to move backward through movie-hold down to continue rewind; Fast Forward Button, to rotate through library to the right or step through menu choices right, and to move forward through movie, press up to 3 times to fast forward more rapidly; Skip Button, to sort movies by category up or step through menu choices up, and to step forward through chapters; Power Button, to turn on/off the controller 100; and Eject Button, to eject a DVD/CD, if loaded. In addition, the front panel of the controller 100 includes a Slot-in Optical Disk Drive which accepts a DVD/CD, and an Integrated VFD Module, which displays the current status of the controller 100.

The back panel of the controller 100 includes a Power Switch, which controls power supply to system, and a Power Jack (AC in), which connects to a power cord. The back panel also has various output jacks 120, including Component Video Out to receive component video cables (red, green, and blue); Audio RCA (Radio Corporation of America) Out, which receive Audio RCA cables; HDMI Out (HDMI cable can be plugged in here); USB 2.0 Ports (USB devices i.e. keyboard, speakers, etc. can be plugged in here); IEEE 1394 Port (6-pin) (FireWire or i.LINK cables can be plugged in here); A/V (Audio/Video) Out (A/V cables—red, white, and yellow—can be plugged in here); S-Video Out (S-Video cable can be plugged in here);

SCART Out (SCART cable can be plugged in here); VGA (Video Graphics Array) Out (D-Sub) (VGA cable can be plugged in here); LAN (Local Area Network) Jack (RJ45) (Internet cable can be plugged in here); PCI (Peripheral Component Interconnect) Expansion Slot (expansion slot available for hardware upgrades); Digital Audio Out (Coaxial) (Coaxial audio cable can be plugged in here); and Digital Audio Out (Optical) (Optical audio cable can be plugged in here).

The remote control device 200 has buttons which are used by the user to control the operation of the controller 100, including those set forth in Table 1 below.

TABLE 1
Remote Control Guide

| Button | | Description |
|---|---|---|
| 1 | Power | Displays the Power Off menu. To turn on Controller 100, use |
| | | the Power Button on the front of the unit. |
| 2 | Sort | Selects Sort category. Movie categories are Alphabetical, |
| | | Genre, Rating, Runtime, and Year. Music are Alphabetic, Artist, |
| | | Genre. |
| 3 | Info | Displays information about the selected movie. |
| | | While watching movie, displays movie menu. |
| 4 | Up | Sorts movies by category; steps through menu choices. |
| 5 | Right | Rotates through library to the right; steps through menu choices. |
| 6 | OK/Play | Plays selected movie/music or selects the desired action from a |
| | | menu. |
| 7 | Pause | Pauses movie. |
| | | Pauses/Starts Music/Restarts Last Selection. |
| | | Note: Pause then FF is slow motion. |
| 8 | Alpha- | Enter numbers or text for various menu choices, also, while |
| | numerical | viewing DVD: ¶3 - Resets Zoom: ¶6 - Zooms Out: ¶9 - |
| | | Zooms In |
| 9 | 5/Space | Enter FIVE or blank space for various menu choices. Also used |
| | Capture | for Cover Capture - see Loading Home Movies. |
| 10 | Mute | Turns sound off. |
| 11 | VOL+ | Increases volume. |
| 12 | VOL− | Decreases volume. |
| 13 | Next | Steps forward through chapters while watching movie. |
| 14 | Previous | Steps backward through chapters while watching movie. |
| 15 | Rewind | Moves backward through movie - hold down to continue |
| | | rewind. |
| 16 | Fast | Moves forward through movie, press up to 3 times to fast |
| | Forward | forward more rapidly. |
| 17 | Clear/Del | Clears text. |
| 18 | Down | Sorts movies by category; steps through menu choices. |
| 19 | Stop | Stops the selected movie. |
| 20 | Left | Rotates through library to the left; steps through menu |
| | | choices. |
| 21 | Back | Displays the Home screen. |
| 22 | Menu | Displays/removes main menu. |
| 23 | Aspect | Selects aspect ratio options. At the Home Screen, the Pause |
| | | button must be pressed directly prior to the Aspect button being |
| | | pressed in order to change aspect ratio. |
| 24 | Subtitle | Multi-purpose: Switches Media Mode between Films, Music, |
| | | and Home Movies. While viewing movies it displays subtitles, |
| | | press to select subtitle language. |
| 25 | Audio | Multi-purpose: If available, displays language options. |
| | | For music, it will turn the On Screen Display On and Off. |

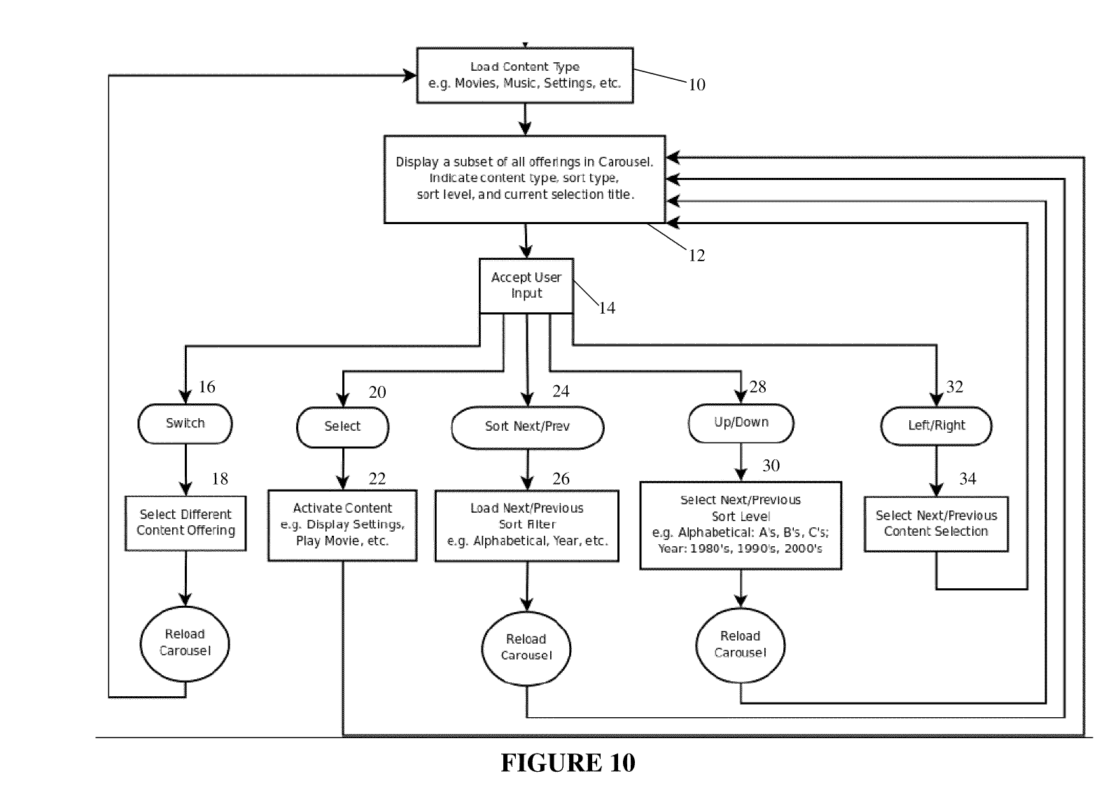

The operation of the controller 100 proceeds in accordance with step 10 of FIG. 10, where the user can load movies or music to the user's library. To load a movie on the controller 100, the user will first see a welcome message. The user then loads a selected DVD into the controller 100 by inserting the selected DVD into the disk drive. The user is then presented with the options of Play DVD, Add Movie to Library, Add Entire DVD to Library, or Eject DVD. The user uses the Up and Down buttons to select Add Movie to Library or Add Entire DVD to Library, and clicks OK. In addition, the first time a studio movie is loaded, the system must install a “libdvdcss” DVD player library from the Internet. Accordingly, a message appears to explain the installation of “libdvdcss”. The user then goes to the Main Menu and selects Settings. On the Settings menu, select Install and use the text keys on the remote control to type in “libdvdcss” by finding the remote button that displays the correct letter, and pressing it until the proper letter appears on the screen. This corresponds to the placement of the letter on the button, i.e., if it is the third letter, the use will press the button 3 times. Lower case letters will appear first, followed by upper case as the user continues to press the button. The cursor waits for the user to enter the next letter. The Clear button is used to clear text as needed. Installation then proceeds, and a message appears “Installing libdvdcss . . . ”. A message “Installation Complete” will display when done, and the controller 100 will automatically restart. “Package Installed” will display upon restart.

At this point, the Home screen appears, such as shown in the embodiment of FIG. 1. The user can go to the Main Menu and select DVD Menu to Add Movie to Library or Add Entire DVD to Library. The system may determine that the movie already exists, or ask the user to rename the movie. If the title is correct or not renamed, the user verifies that the movie already exists by selecting Cancel Addition to return to the Home screen and search the carousel of movies for existence of the movie. The Home screen appears again, and the top left corner of the screen displays the title of the movie being added to the library with the status of the loading displayed in the top right corner of the screen. If the proper title of the movie is not displayed while the DVD is loading, a search for the correct title can be conducted at a later time.

Once the movie is added to the user's library, the cover art is displayed on the Home screen. After the movie is loaded, a menu may appear that allows the user to choose the correct title of the movie. The user may scroll down the list of title choices and select the correct name of the movie. The cover art and movie title will then be added to the user's library. If the user does not see the correct movie title listed, the movie title can be changed. At any time during this loading process, the user can cancel the addition to the library.

At step 10, the user can also load home movies onto the controller 100 to be placed into the user's library. Loading home movies is the same as loading studio movies with one exception (which may be optional). Before loading a home movie into the user's library, the user changes the mode on the controller 100 to “Home Movie”. On the Main Menu, the user highlights Mode: Films and press the right arrow button on the remote control until Home Movies is displayed. The user selects Home Movies. In addition, the user uses the Capture button (0) on the remote 200 to select a scene from the user's home movie to use as the cover art to represent that home movie on the carousel. The user presses Capture (0) during the chosen scene and it will automatically be selected and applied as the cover art.

The controller 100 currently supports camcorder functions through a FireWire or i.LINK cable. The camcorder is connected to the 4-pin IEEE 1394 port in the front or the 6-pin IEEE 1394 port in the back. To load a movie from a camcorder, the user would go to the Main Menu, highlight Mode, select Home Movies, and press OK. Turn the camcorder on and set it to the point where the user would like to begin the Home Movie. A menu is then displayed for the user to either Play or Add Movie to Library. If Add Movie to Library is selected, the user is prompted to enter a title for the home movie. The camcorder will begin to play from its current position. To stop recording, go to the Main Menu, select Camcorder, and select Finish Addition. Cover art can then be added to the home movie. To play a movie from a camcorder, select Play from the Camcorder menu.

Music can also be loaded to the controller 100 and added to the user's library, at step 10. Prior to the installation of music on the controller 100, a “Music Library is empty” message is displayed on the screen. The user then loads the selected CD into the controller 100 by inserting the selected CD into the disk drive. The user is then presented with a menu to either Play CD, Add Music CD to Library, or Eject CD. The user selects Play CD or Add Music CD to Library. The Home screen appears, and the top left corner of the screen displays the title of the music being added to the library with the status of the loading displayed in the top right corner of the screen. Once the music is added to the user's library, the cover art is displayed on the Home screen. The cover art and CD title will then be added to the user's library. The user may change the title and/or cover art via the Main Menu entry for the title. This is done by rotating to the desired CD, press the Menu button, Press OK on “Selected Album”, Press—(Down arrow) to select “Change Cover” and Press OK. At any time during the loading of the music, the user can decide to cancel the addition to the library.

At this point, the home screen shown in FIG. 1 is displayed, and the system proceeds to step 12 of FIG. 10. The number of images that can be displayed on the Home Page is defined by the user, so that only a subset of movies/music is displayed at any one time if there are more movies/music than permitted by the user to be displayed. Here, the user can view the carousel of loaded movies/music on the Home screen, and enter commands, step 14. The bottom left corner shows an icon for the currently selected mode (Films, Music, or Home Movies). The bottom left corner also displays the currently selected sort mode (Alphabetical, Genre, Rated, Runtime, or Year). The most prominently displayed and highlighted movie in the carousel can be selected to play by clicking the OK button. With the use of the remote control, the user can easily sort and select movies from the library.

From the home screen, the user can use the remote control 20 to perform various functions. For instance, the user can use the OK Button to play the selected movie, steps 20, 22. The Right Arrow rotates and selects the movie on the right of the current movie into view, and the Left Arrow rotates and selects the movie on the left of the current movie into view, steps 32, 34. The Sort Button navigates through the different methods of sorting, steps 24, 26. The Up/Down Arrows navigate through the method of sorting that is selected, steps 28, 30. The Menu Button displays the Main menu, the Info Button brings up information about the selected title, and the Power Button displays the Power Off menu.

In addition, the remote control 200 can be used to select Film, Home Movie, or Music Mode. To do so, the user presses Menu, uses the Up/Down buttons to highlight the “Mode:” selection, use Left/Right buttons to select desired mode (“Films”, “Music”, or “Home Movies”), press OK. The controller 100 will switch to the desired mode and display the Home carousel, steps 16, 18.

To watch a movie, the user clicks OK when the desired movie is presented on the Home screen as the user rotates through the carousel of movies. The controller 100 has sorting capabilities via the Sort button and Up/Down buttons, steps 28, 30. All three buttons will help the user narrow down the choices, thus refining the selection process. To listen to music, the user clicks OK when the desired CD is presented on the Home screen as the user rotates through the carousel of music.

The controller 100 is also able to sort the movies, steps 24, 26. The bottom left-hand corner of the Home screen displays the sorting category that is currently selected, along with the number of movies in each category. The default category is “Alphabetical”, as is shown in FIG. 1. The Genre sub-category displayed is driven by the sub-categories of movies loaded into the library. For example, if the user has loaded science fiction and comedy movies, the user will see “Genre: Science Fiction” and “Genre: Comedy”. As more movies are loaded into the library with a variety of genres, more Genre sub-categories will appear.

To select a category, the user would click on Sort and keep clicking until the desired category is displayed. The Up/Down buttons are used to rotate through sub-categories within the category selected. The Left/Right buttons are used to revolve through the carousel of displayed movies until the desired one is prominently displayed. Click OK to start the movie. The user can also watch a movie even while a movie is being loaded into the library. The user would rotate through the library from the Home screen and click OK to watch the chosen movie. The selected movie will play as the movie load continues. The user can also listen to music even while a movie/music is being loaded into the library. The user would rotate through the library from the Home screen and click OK to listen to a chosen Album. The selected title will play as the movie/music load continues.

When the Menu button is selected, a Main Menu is displayed for Selected Movie, DVD Menu (this only appears when a DVD is physically in the DVD drive), Mode:, Parental Controls, Settings, and Power Off. The Main menu is the primary means of operating the controller 100. If Selected Movie is chosen, the user can either Play Selected, Show Info, Edit Info, or Delete Selected. To play the selected movie, the user would choose Play Selected. When Show Info is selected, a screen similar to the one shown in FIG. 2 is displayed. This screen can also be displayed from the Home screen by clicking the Info button. As shown, this screen shows an enlarged cover-art photo, the title, a brief overview of the plot, and other information about the movie, including director, cast, writer, genre, year, run-time, user rating (1-10), and parental rating information. From this screen, the user can play the movie, or hit the Back Button or Menu Button to return to the Home screen.

If the Edit Info option is selected, the user can change the movie title as needed. The controller 100 searches the Internet for title information, which may sometime result in several options. The user can view the possible title options by selecting Search Internet for Movie Info. The user can also specify whether the selected movie is a “Film” or a “Home Movie”. When the user first loaded the movie into the library, it is classified based on the mode the user selected at the time of loading. When the user selects to Search Internet for Movie Info, the various title options are displayed if the controller 100 is connected to the Internet and has found information options when searching the Internet. Multiple movies may be listed here. The controller 100 highlights a best option, but the user can select any of the titles or enter a new title. All relevant movie information is updated based on the user's selection.

The user can also use the Adjust Level option to change the rating level of the movie on a scale from 1-5 and click OK. The default for this option is the MPAA rating. The user can also clear the existing information for the selected movie. To do this, highlight Clear Info and click OK. The movie title will be reset to the title originally chosen by the controller 100. Use Search Internet for Movie Info option to recapture the cover art and show information. The user can also delete the selected movie from the library.

When a DVD is inserted into the controller 100, a DVD menu is available. The DVDI menu allows the user to Play DVD, Add Movie to Library, Add Entire DVD to Library, or Eject DVD. The user selects Play DVD if the user wishes to play the DVD without loading it into the user's library. Selecting Add Movie to Library usually means that only the feature movie from the DVD will be loaded into the user's library. If there is a collection of items on the DVD, the software will select the largest item, which is usually the feature movie, but not always. If the feature movie is not added, choose to add the entire DVD. The Home screen appears. At the top left corner of the screen is displayed the title of the movie being added to the library along with the status of the load in the top right corner. If the proper title of the movie is not displayed while the DVD is loading, a search for the correct title can be conducted at a later time if necessary.

Once the movie is added to the library, the cover art is displayed on the Home screen and the addition is reflected in the category choices at the bottom of the screen. After the movie is loaded, a menu may appear that allows the user to choose the correct title of the movie. Scroll down the list of title choices and highlight the correct name of the movie. Click OK. The cover art and movie title will then be added to the user's library. If the correct movie title is not listed, the user can edit the movie title.

The Add Entire DVD to Library option loads the additional items that come on the DVD as well as the feature movie. The extra items on a DVD may vary, but often include the following: Language Options, Sneak Peeks, Scene Selection, and Special Features. This may not be an option for every movie which is added to the library.

The controller 100 allows the user to group movies into two major types: “Films” and “Home Movies”. If “Films” is selected, the carousel on the Home screen will reflect this by displaying only movies classified as films (studio movies) with the full range of sorting capabilities. Likewise, if the user has selected “Home Movies”, only movies classified as home movies will be displayed in the carousel with the full range of sorting capabilities. The selected mode is indicated in the bottom left hand corner of the Home screen with an icon.

The Parental Controls option allows the user to setup a passcode to Disable Parental Controls, Block, or Set Passcode. If Disable Parental Controls is selected, the parental control level is disabled allowing all movies to be displayed. The Block option is used to specify the ratings of movies that is to be blocked from viewing in the carousel of movies. For example, selecting a rating of PG-13 will block PG-13 rated movies and higher from being displayed on the carousel for viewing. Use the Left/Right arrow to change this setting and click OK. Select “None” to allow all movies to be displayed. The Set Passcode option is used when the user is initially setting up a passcode or wishes to change an existing passcode.

The Settings option allows the user to manage some of the basic properties of the controller 100, including Networking, Audio, Camcorder, Remote Delay Rate, Check for Updates, Install, Send Reports, and displays the number of hours of storage available in the controller 100.

The Networking option presents a menu having Networking, Status, Connection, Configuration, IP, Refresh Network, Signal Strength, Wireless Setup and Static IP Setup. The Networking option displays the system's network connection status. The Connection option lets the user choose between a wired or wireless network. The Configuration option lets the user choose between a DHCP (Dynamic Host Configuration Protocol) connection and Static IP connection. The IP option displays the system's network Internet protocol (IP) address. The Refresh Network option resets the Internet connection. The Signal Strength option displays the strength of signal for wireless connection. The Wireless Setup option is reached by selecting Wireless for Connection type in the Networking menu and click OK. The user can select a Network by using the Left/Right arrows. If the network router security is turned off (no password), click OK. If there is security for the user's network, the user must enter the password, select the password format, and click OK. Formats supported include WEP (Wired Equivalent Privacy) (hex), WPA, and WPA2 (Wi-Fi Protected Access). Finally, under the Networking option, the Static IP Setup option allows the user to manually enter the IP address on the given line. The user should then select Refresh Network.

Under the Settings option, the Audio option allows the user to choose between Stereo, 7.1 Surround, and Digital Pass Thru. The Camcorder option allows the user to choose between Standard and High Def. The Remote Delay Rate option has a default value of 300. If the user finds that the remote responds too quickly or double clicks, this setting can be increased. If the remote responds too slowly, this setting can be decreased. The Check for Updates option is used to update the controller 100. The controller 100 will access the Internet and check for controller 100 updates. If available, the controller 100 will be automatically updated. If no updates are available, a message will be displayed. The Install option is used to install extra software packages as needed. The Send Reports option is used to send log reports so they can be reviewed to resolve problems. The Storage option displays the number of hours of free space remaining on the controller 100.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A method for sorting, searching, and displaying information comprising the steps of:
providing a memory that can store information and can store additional information that is the result of a search or sort process,
assigning a graphical picture to represent each element of information that is stored in the memory despite the type of information,
enabling a user to reassign or select a different graphical picture representation for each element of information,
displaying a set of information using the graphical picture representation of the elements of information in a carousel format to enable the user to see the information,
limiting the number of elements of information displayed at once by a subset setting so that the user is not presented with all of the graphical pictures for the information at once,
using a sort command from a remote control or other input device to cause the graphical picture information on the screen to be re-organized by the sort criteria,
using a search command from a remote control or other input device to cause the graphical picture information on the screen to be re-organized by the search results,
assigning additional descriptors to each element of information so that these descriptors can be used to sort the information,
enabling the user to edit the additional descriptors to add user preference and user customization,
whereby these features enable the user to easily aggregate, search, sort, and manipulate the information.

2. The method of claim 1, wherein each element of information comprises a movie.

3. The method of claim 1, wherein each element of information comprises music.

4. A system for managing information comprising:
a memory that can store information and can store additional information that is the result of a search or sort process, and
a processor for:
assigning a graphical picture to represent each element of information that is stored in the memory despite the type of information,
enabling a user to reassign or select a different graphical picture representation for each element of information,
displaying a set of information using the graphical picture representation of the elements of information in a carousel format to enable the user to see the information,
limiting the number of elements of information displayed at once by a subset setting so that the user is not presented with all of the graphical pictures for the information at once,
using a sort command from a remote control or other input device to cause the graphical picture information on the screen to be re-organized by the sort criteria,
using a search command from a remote control or other input device to cause the graphical picture information on the screen to be re-organized by the search results,
assigning additional descriptors to each element of information so that these descriptors can be used to sort the information,
enabling the user to edit the additional descriptors to add user preference and user customization,
whereby these features enable the user to manage the information.

5. The system of claim 1, wherein each element of information comprises a movie.

6. The system of claim 1, wherein each element of information comprises music.

7. A system for managing a plurality of information elements for use with a display screen, the system comprising:
a memory that stores the plurality of information elements;
a user input; and,
a processor that associates a graphical picture with each of the plurality of information elements in response to the user input, arranges a predefined number of the graphical pictures in a carousel format, and rotates through the arranged graphical pictures in response to user input.

8. The system of claim 7, wherein each of the plurality of information elements comprise a movie.

9. The system of claim 7, wherein each of the plurality of information elements comprise music.

10. The system of claim 7, wherein the carousel format includes a single selectable information element which is at a center position and is larger than each of the non-selectable plurality of information elements, wherein each non-selectable information element becomes the selectable information element when rotated to the center position and the selectable information element becomes a non-selectable information element when rotated away from the center position.

11. The system of claim 10, wherein said processor plays the selectable information element in response to the user input.

12. The system of claim 7, wherein said processor associates a different graphical picture with one of the plurality of information elements in response to the user input.
